(19) United States
(12) Patent Application Publication
(10) Pub. No.: US 2005/0166715 A1
(43) Pub. Date: Aug. 4, 2005

(54) Tong assembly

(76) Inventor: Tommie L. Rogers, Lafayette, LA (US)

Correspondence Address: ONEBANE, BERNARD, TORIAN, DIAZ, MCNAMARA & ABELL, P. O. BOX 3507, LAFAYETTE, LA, 70502, US

(21) Appl. No.: 10/771,265

(22) Filed: Feb. 3, 2004

(51) Int. Cl. B25B 17/00

(52) U.S. Cl. 81/57.16

(57) ABSTRACT

A tong assembly comprising a power tong and a backup assembly. The backup assembly comprises a pair of rotating jaws, each of which carries a jaw die which is rotated into and out of engagement with a tubular being gripped by the backup. The jaw die has a base portion and a gripping surface portion. The gripping surface portion has a profile shape, the profile shape being non-symmetric around a center line through the base portion and normal to the base portion. The non-symmetric profile shape permits an increased range of tubular diameters to be gripped by the backup.

### BACKGROUND—FIELD OF ART

This invention relates to apparatus used in the joining together (screwing together and unscrewing) of threaded tubular connections. More particularly, this invention relates to a tong assembly (power tong or backup tong) capable of grasping a larger range of tubular diameters, and comprising configurations of gripping dies therein.

### BACKGROUND—RELATED ART

Powered devices to screw together (“makeup”) and unscrew (“breakout”) threaded tubular connections have been in use for some time. In particular, such devices, often broadly referred to as “power tongs,” have long been in use in the oil and gas drilling and completion industry. These power devices have been used to makeup and breakout a wide range of sizes of threaded tubulars, from tubing (for example, as small as 2⅜″ OD or smaller) to casing (for example, as large as 16″ OD or larger).

It is important to understand that most of the devices referred to broadly as “power tongs” are perhaps more accurately referred to as a “tong assembly,” comprising two main components: the first is the actual power tong, which is the component which rotates the tubular comprising one side of the threaded connection (e.g., the male or pin); and the second is the backup assembly, which grips the tubular comprising the other side of the threaded connection (e.g., the female or box connection), keeping it from rotating and thereby permitting makeup of the connection. Often, the power tong and backup tong are coupled to each other, forming an “integral backup” tong assembly.

It is desirable for a single tong assembly to be capable of handling tubulars over a wide range of diameters. However, there are several limiting factors which generally confine a single tong assembly to effectively handling only a relatively small range of diameters of tubulars. One such factor is the torque which must be applied to properly make up the connection, or break it out. Generally (although different types of threads have different torque requirements) the larger diameter tubulars require higher torque capability. Therefore, a tong assembly capable of torque requirements for a wide range of tubular diameters may be much larger than required (hence more expensive and more difficult to handle) for small tubulars; and of course a tong assembly especially suited for small diameter tubulars would not be capable of the torque requirements for large tubulars.

There are other requirements which generally confine power tong units to relatively small ranges of tubular diameters. Due to the geometry of the various parts of both power tongs and backup assemblies, the gripping range is relatively small. Typically, the power tong has a gripping range of about 1″ (that is, can effectively grip and rotate tubulars over a 1″ range of outer diameters, for example from 6″ to 7″ OD). The backup assembly often has a smaller tubular diameter range, often around ½″. With respect to the backup assembly, the smaller range is dictated by the jaw and die configuration.

As can be seen in FIG. 1 (which is a top view of a prior art backup assembly), the backup assembly 10 typically has a pair of jaws 20, each of which has a die 30 mounted thereon. Jaw 20 rotates around a hinge pin 22 mounted in the body 24 of the backup assembly (usually via a gear assembly driven by a hydraulic cylinder), thereby swinging the die into and out of engagement with the tubular to be gripped (as shown by the notation of “Engaged position,” directional arrow, and phantom lines).

Referring to FIGS. 2 and 3, a typical die 30 has a base portion 31 and a gripping surface portion 32. Base portion 31 fits into jaw 20, and permits die 30 to be securely mounted on the jaw, usually by means of a pin inserted through a projecting portion of the die. Gripping surface portion 32 generally has a toothed surface which permits the die to bite into the tubular being gripped. Dies have a profile shape, which is the shape seen from a direction parallel to the axis of a tubular being gripped, and is the shape presented in FIG. 3, for example (corresponding to a top or bottom view of the die, when mounted in its typical position in a backup assembly). FIG. 3 is a typical prior art die profile shape, which is generally symmetric about a centerline CL which approximately bisects (and is at right angles to) the width X of the base portion 31. Dies are generally made of a hardened steel.

Prior art dies were often referred to as “double sided,” “bi-directional” or reversible dies. As described above, such dies are generally symmetrical in profile around a center line CL through base portion 31, as is readily seen in FIG. 3, and can be removed and “flipped over” or reversed in position, then re-mounted on the jaw. When the teeth on the gripping surface on one side of the center line of the gripping surface become worn and no longer effectively bite the tubular, the unused teeth on the other side of the center line can be employed. The symmetrical aspect of the die dictates, however, that only about ½ of its arcuate length (that is, the length around the curve of the die gripping surface) can be used to grip the tubular. As can be readily seen from the geometry of the tool, this is a limitation on the gripping range of the tool.

It can be readily appreciated that the limited range of tubular diameters which could be gripped by a backup assembly presents a limitation on the utility of such devices. The requirement of changing out various components of the backup assembly, in order to provide a grip range capable of accommodating a larger or smaller tubular, is costly. A significant advantage results from a die configuration which would permit handling of an increased range of tubular diameters without requiring the change of other tong assembly components.

### SUMMARY OF THE INVENTION

The present invention comprises a tong assembly, more particularly comprising a backup assembly, having an improved die and jaw assembly which permits effective gripping of an increased range of tubular diameter. The backup assembly comprises typically two jaws which rotate about respective hinge pins, to swing the dies into and out of engagement with the tubular being gripped. Only one of the jaw/die combinations swings into engagement with the tubular at a time, depending upon whether the tubular is being “made up” (that is, being screwed together) or “broken out” (unscrewed).

The die has a base portion (which fits into the jaw, permitting secure attachment of the die to the jaw, typically via a pin arrangement) and a gripping surface portion, which presents typically a toothed or serrated surface against the tubular in order to bite into and firmly hold the tubular against undesired rotation. The gripping surface portion of the die of the present invention permits an increased range of tubular diameter which can be gripped, since the gripping surface extends beyond the usual midpoint of the arcuate gripping surface length as in prior art dies. In addition, the profile of the backup jaw die decreases both the loading on the hinge pin and the radial loading on the tubular, while increasing the lateral force applied to the tubular. The lateral force is the component of the overall force diagram which effectively prevents rotation of the tubular. In one presently preferred embodiment, the gripping surface of the present invention comprises a portion of an arc of a circle, wherein the center of the circle does not lie on the centerline through the base portion (that is, the line of symmetry of the base portion), but instead is offset, typically in a direction away from the hinge pin of the jaw. Conventional bidirectional die shapes permit reversing the die (in its placement in the jaw) in order to double the useful service life of the die, but do not permit gripping where the point of contact on the tubular is past the centerpoint of the die. The improved die shape permits the point of contact with the tubular to be past the centerpoint of the arcuate die gripping surface length, therefore yielding an increased gripping range.

### BRIEF DESCRIPTION OF THE DRAWINGS

FIG. 1 shows a prior art tong assembly, including backup jaws and dies.

FIG. 2 is further detail of a prior art backup jaw and die.

FIG. 3 is further detail of a prior art die profile.

FIG. 4 is a tong assembly of the present invention.

FIG. 5 shows a die corresponding to the present invention, mounted in a tong jaw.

FIG. 6 is another view of the improved die profile.

FIG. 7 is a view of a die profile of the present invention, engaging a tubular.

FIGS. 8A and 8B show two positions of the die of the present invention engaged on a tubular.

FIGS. 9 and 10 show alternate profile shapes of the die of the present invention.

### DESCRIPTION OF THE PRESENTLY PREFERRED EMBODIMENT

While the present invention may take a number of different embodiments, several of the presently preferred embodiments will now be described, with reference to the drawings. Those having ordinary skill in the relevant art field will recognize that embodiments other than those specifically disclosed may be made, without departing from the scope of the invention.

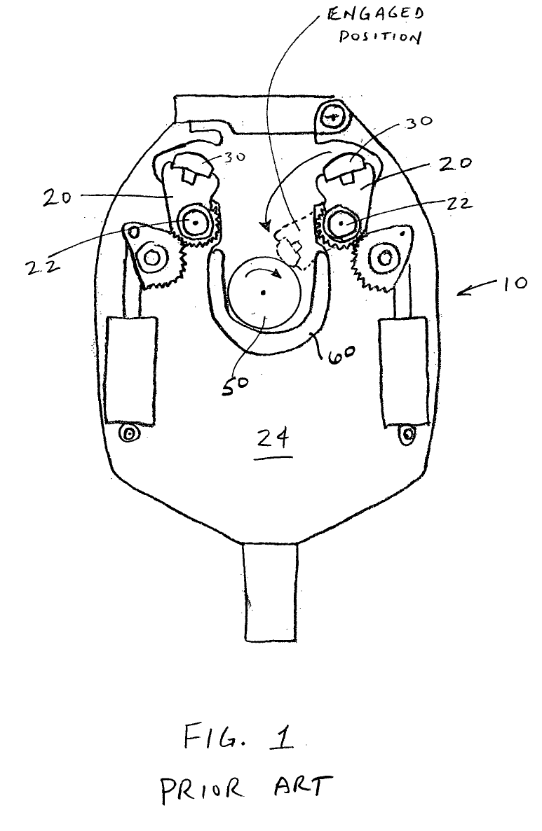

FIG. 1 is a view of a typical prior art backup assembly. FIG. 1 further shows one jaw in an engaged position against the tubular (as indicated by the dotted line position). The arrow illustrates the direction of rotation of the jaw to bring the die into engagement with the tubular.

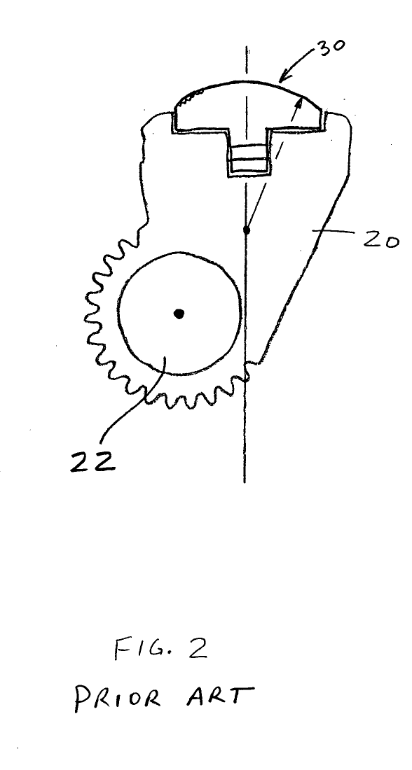

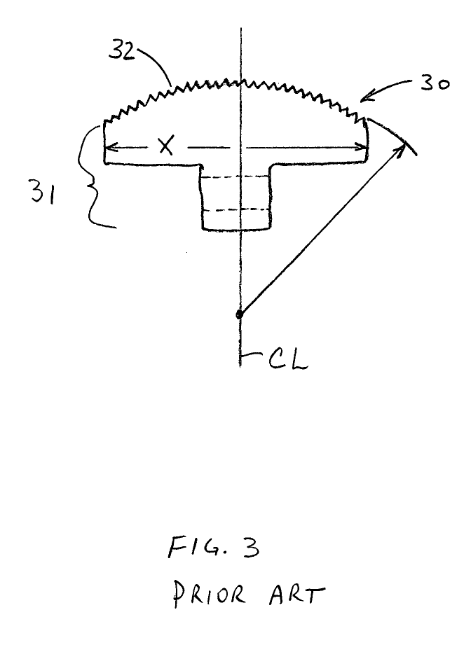

Referring to FIGS. 2 and 3, the gripping surface of a typical prior art die is symmetrical about a center line midway through the width X of the die. The effective gripping surface (along the arcuate face) is only up to the center line of the die. It can be readily seen that the prior art die gripping surface is usually a portion of an arc of a circle, as is particularly shown on FIG. 3, symmetric about the center line CL.

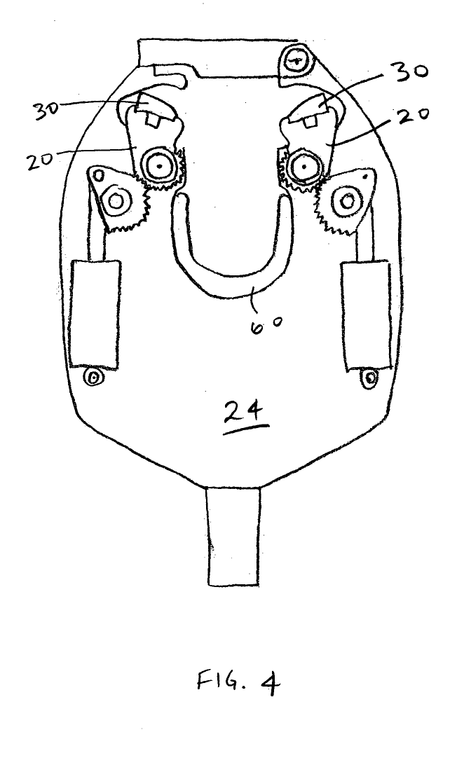

FIG. 4 is a drawing of a tong assembly, more particularly a backup assembly, comprising the present invention.

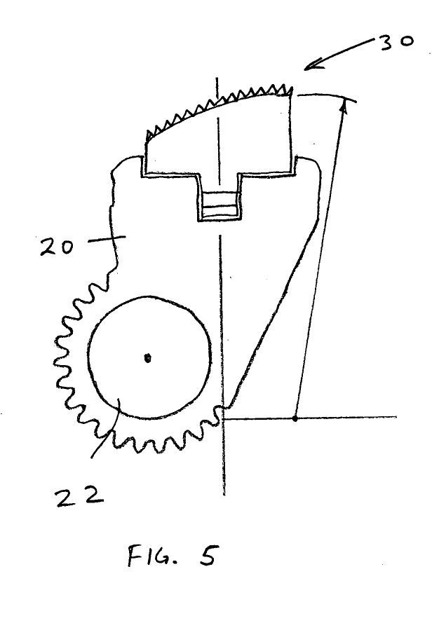

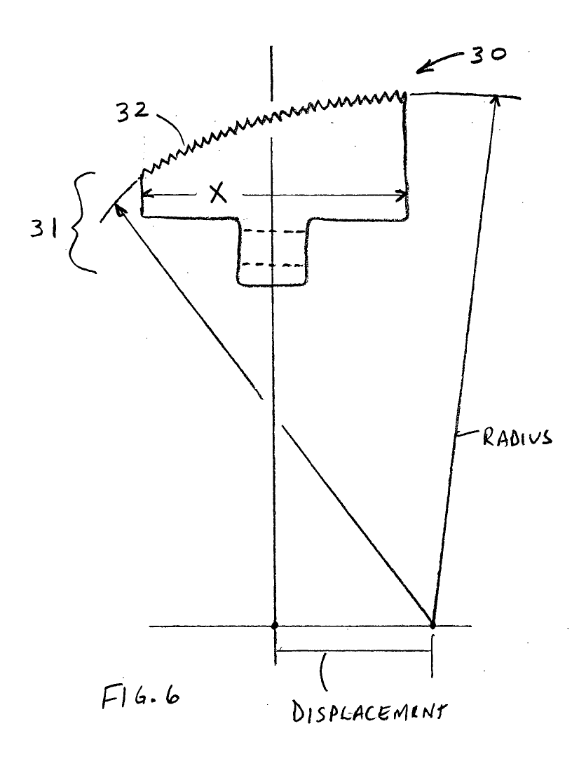

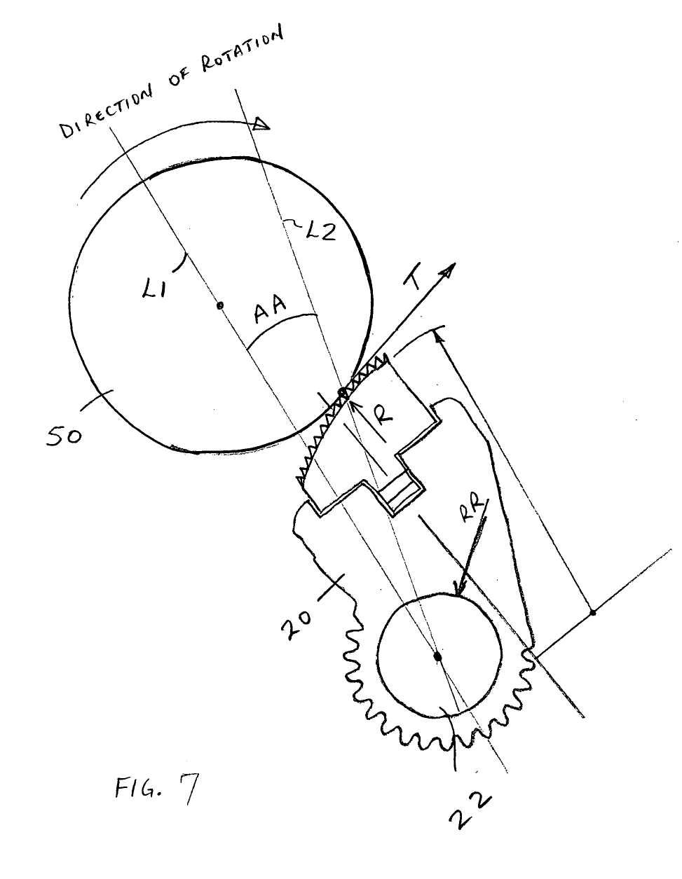

Referring to FIGS. 5 and 6: further detail of the die of the present invention is set forth. As can be readily seen in FIG. 6, one presently preferred embodiment comprises a die profile shape corresponding to a segment of the arc of a circle. The circle has a radius as shown, but the center of the circle is displaced from the center line CL of the die, as noted. The radius and displacement distance can be varied to suit specific combinations of tubulars and tong assembly components. FIG. 7 is another view of a jaw/die combination of the present invention, along with additional information relating to the forces on the tubular and the jaw, resulting from the new die shape. FIG. 7 shows jaw 20 mounted on its hinge pin 22, with die 30 rotated into contact with tubular 50. FIG. 7 also shows the force between die 30 and tubular 50, which can be resolved into a radial force R and a tangential force T. Tubular 50 may be drill pipe, or may be any other tubular having threaded connections for joining together joints or sections. A reactive force RR between hinge pin 22 and jaw 20 balances the radial and tangential forces. A cam angle AA is defined as the angle between (1) a line through the center of the hinge pin and the center of the tubular, designated L1, and (2) a line through the hinge pin and the point of contact between the die and the tubular, designated L2. The following table set out representative calculations for convention, or “double sided” dies, compared to the improved die configuration of the present invention.

Prior Art Die (Symmetrical)

Based on 100,000 ft-lb. Torque

| | | | Cam | | | Jaw |
|---|---|---|---|---|---|---|
| Backup | | | angle | | | Pin |
| Pipe | Hook | Tubular | AA | Tangential | Radial | Load |
| Range | Size | OD | (de- | Force T | Force R | RR |
| (inches) | (inches) | (inches) | grees) | (lbs.) | (lbs.) | (lbs.) |
| 4.5-5.0 | 4.5-5.0 | 4.5 | 4.0 | 271,493 | 1,021,476 | 1,022,586 |
| 6.0-6.5 | 6.0-6.5 | 6.0 | 5.8 | 204,778 | 655,593 | 657,094 |
| 6.0-6.5 | 6.0-6.5 | 6.25 | 7.9 | 198,675 | 489,137 | 491,225 |

Present Invention Die (Non-Symmetrical)

Based on 100,000 ft-lb. Torque

| | | | Cam | | | |
|---|---|---|---|---|---|---|
| Backup | | | angle | | | Jaw Pin |
| Pipe | Hook | Tubular | AA | Tangential | Radial | Load |
| Range | Size | OD | (de- | Force T | Force R | RR |
| (inches) | (inches) | (inches) | grees) | (lbs.) | (lbs.) | (lbs.) |
| 4.5-5.5 | 5.0-5.5 | 4.5 | 7.8 | 292,683 | 490,582 | 492,618 |
| 5.5-6.5 | 6.5-7.0 | 6.0 | 9.7 | 216,606 | 366,021 | 368,390 |
| 5.5-6.5 | 6.5-7.0 | 6.25 | 10.3 | 207,612 | 350,755 | 353,321 |

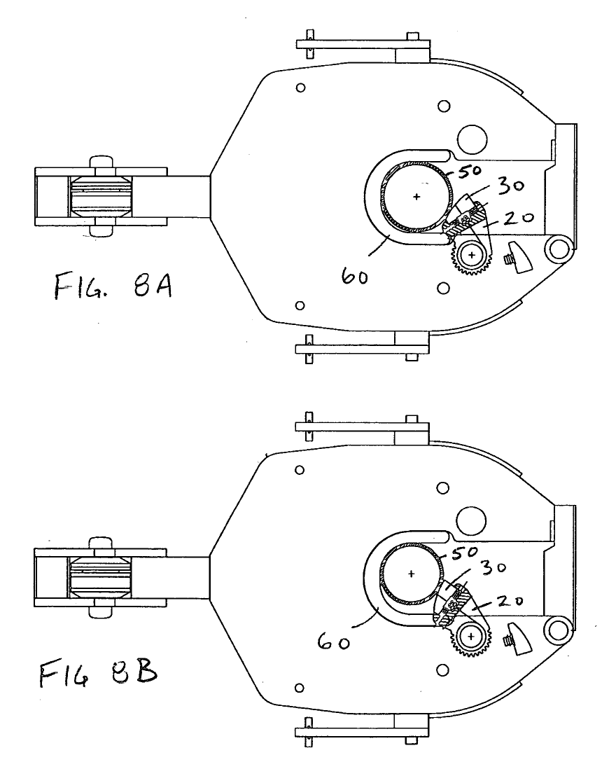

It is to be understood that these tables present only some of the various embodiments comprised by the present invention. Many combinations of sizes are possible. The “Hook Size” in the preceding charts refers to the hook shaped member within the body of the backup assembly which receives the tubular, and refers to the nominal range of tubulars which can be accommodated by the hook shaped member (hook 60). FIGS. 8A and 8B are top views of the backup assembly with a tubular in place in hook 60 and engaged by a die of the present invention. FIG. 8A is a relatively large diameter tubular, and it can be seen that the point of contact is on one side of the center line of die 30. FIG. 8B shows a relatively small diameter tubular, wherein the point of contact is on the other side of the center line of die 30.

It is to be noted that the die of the present invention, in the example shown, presents reduced radial forces on the tubular and consequently on the hinge pin. The force lateral to the tubular, which is the force preventing the tubular from turning, is increased; while at the same time, the radial force imposed on the tubular is decreased. This radial force reduction can be very important, especially with certain types of tubulars. In the embodiment shown, the contour of the die is a segment of the arc of a circle, however unlike prior art die shapes, the center of the circle (from which the arc emanates) does not lie on the centerline bisecting the die width, but instead is displaced to one side, away from the hinge pin. This relationship is readily seen in FIG. 6. It is to be noted that the useful gripping surface comprises substantially the entirety of the gripping surface length, unlike the effective length of the prior art die, effectively only ½ of the gripping surface length.

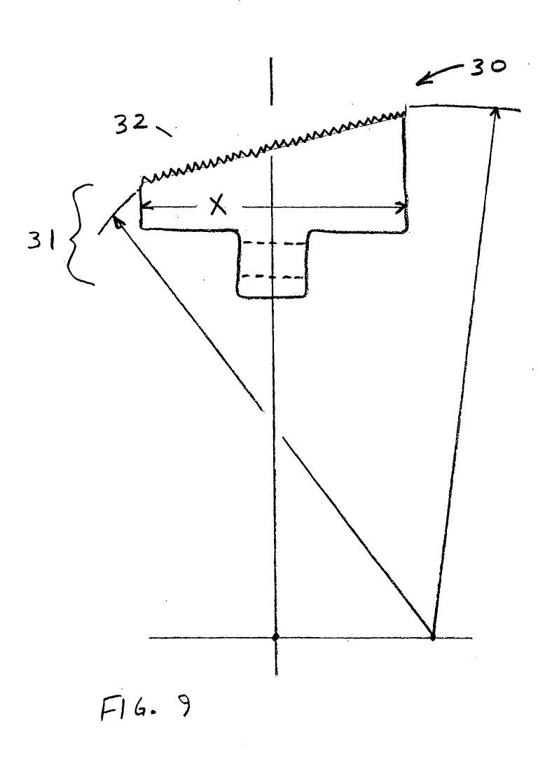

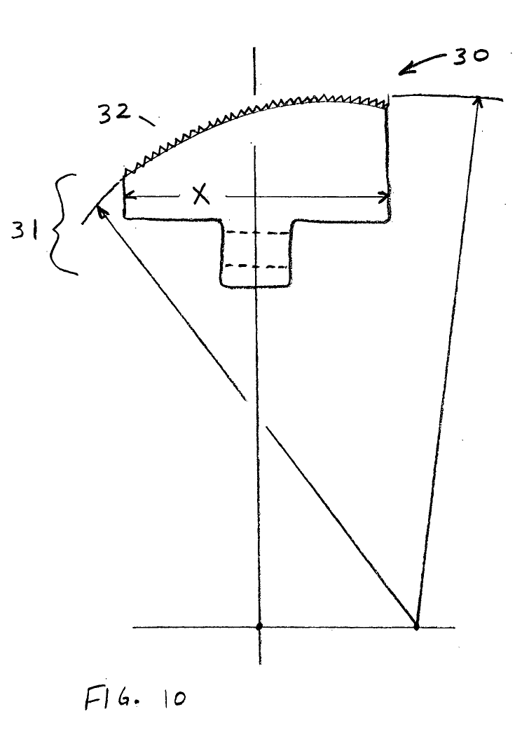

FIGS. 9 and 10 set out alternative embodiments of the profile shape of the die of the present invention. FIG. 9 shows a die of a substantially straight surface. FIG. 10 is a die with a profile shape comprising a segment of the arc of a parabola. It is to be understood that various other shapes or combinations of shapes (e.g., a combination of a portion of a segment of a circle, and a portion of a segment of a parabola) could be used. The present invention encompasses all such profile shapes, wherein the shapes are non-symmetric about the center line and provide an effective gripping surface over substantially the entirety of the gripping surface.

While the preceding description is a detailed one, setting out various aspects of the presently preferred embodiments, it is nevertheless given for illustrative purposes only and not by way of limitation. Various changes could be made. For example, the die profile can take a number of different shapes, all generally non-symmetric about a center line through the profile; portions of arcs of circles of different radii, differing locations of the centers of any such arcs of circles, sections of parabolas, even straight lines, can all form the die profiles. Dimensions can be altered to suit specific applications. Die materials can differ depending upon the specific tubular material being gripped.

Therefore, the scope of the present invention is not limited to the specific embodiments disclosed, but to the scope of the appended claims and their legal equivalents.

1. An improved tong die, especially suitable for a backup unit in a combined power tong/backup assembly, comprising:
a tong die comprising a base portion and a gripping surface portion, said base portion adapted to be received into a backup jaw and fixed in place therein, and wherein said gripping surface portion, in profile view, is non-symmetric about a centerline through and normal to said base portion.

2. The tong die of claim 1, wherein:
said backup jaw moves around a point of rotation;
said gripping surface portion, in profile view, comprises a segment of the arc of a circle, and
a center of said circle is displaced from a centerline through and normal to said base portion, in a direction away from said point of rotation of said backup jaw.

3. The tong die of claim 1, wherein said non-symmetric shape comprises a parabola.

4. The tong die of claim 1, wherein said non-symmetric shape comprises a substantially straight line, angled with respect to said centerline.

5. A tong assembly comprising:
a) a power tong;
b) a backup assembly coupled to said power tong;
wherein said backup assembly comprises a pair of rotatable jaws, each of said jaws having a tong die mounted therein, said tong die comprising a base portion and a gripping surface portion, said base portion adapted to be received into said jaw and fixed in place therein, and wherein said gripping surface portion, in profile view, is non-symmetric about a centerline through and normal to said base portion.

6. The tong assembly of claim 5, wherein:
each of said jaws moves around a point of rotation;
said gripping surface portion, in profile view, comprises a segment of the arc of a circle, and
a center of said circle is displaced from a centerline through and normal to said base portion, in a direction away from said point of rotation of said backup jaw.
